(19) United States
(12) Patent Application Publication
(10) Pub. No.: US 2021/0203022 A1
(43) Pub. Date: Jul. 1, 2021

(54) INTERNAL BATTERY HEATING UNIT WITH THIN-PRINTED FOIL

(71) Applicant: IEE INTERNATIONAL ELECTRONICS & ENGINEERING S.A., Echternach (LU)

(72) Inventors: Baptiste FAGART, Longwy (FR); Guy WATHIEU, Bridel (LU); Dietmar JUNGEN, Mehren (DE); Michael OLK, Welschbillig-Trag (DE)

(21) Appl. No.: 16/065,531

(22) PCT Filed: Dec. 18, 2016
(86) PCT No.: PCT/EP2016/081649

§ 371 Date: Jun. 22, 2018

(30) Foreign Application Priority Data
Dec. 24, 2015 (LU) 92930

(51) Int. Cl. H01M 10/6571; H01M 50/209; H01M 50/249; H01M 10/48; H01M 10/615; H01M 10/0525; H01M 10/625; H01M 10/653; H05B 3/03; H05B 3/06; H05B 3/26

(52) U.S. Cl. CPC H01M 10/6571; H01M 50/209; H01M 50/249; H01M 10/486; H01M 10/615; H01M 10/0525; H05B 2203/014; H01M 10/653; H01M 10/482; H05B 3/03; H05B 3/06; H05B 3/26; H01M 2220/20; H01M 10/625

(57) ABSTRACT

A battery heating unit for use in a rechargeable battery unit includes a first electrically insulating sheet having even, parallel surfaces, a plurality of electrically resistive, planar heater members, arranged on one of the surfaces of the first electrically insulating sheet, a plurality of electrically conductive contact members that are arranged on the surface of the first electrically insulating sheet, and a plurality of first electrically conductive tracks that are arranged on the surface of the first electrically insulating sheet. The planar heater members are electrically connected by the electrically conductive tracks to the plurality of electrically conductive contact members.

### TECHNICAL FIELD

The invention relates to a battery heating unit for use in a rechargeable battery unit, in particular a rechargeable lithium ion battery, and to a rechargeable electrochemical battery unit, in particular for automotive applications, comprising such battery heating unit.

### BACKGROUND OF THE INVENTION

In the field of rechargeable batteries, in particular for automotive applications, it is well known that proper battery temperature management is crucial for maintaining high performance and longevity. Battery temperature management requires monitoring battery temperature at appropriate locations for control purposes, for instance for triggering a battery cooling system.

For example, patent application publication US 2014/0377598 A1 describes a battery for a motor vehicle. The battery comprises at least one battery cell or a plurality of battery cells, preferably a lithium-ion battery cell, which has a housing with an electrode arrangement arranged therein. A first temperature sensor is arranged outside the battery cell housing, and at least one of the battery cells has a second temperature sensor arranged inside the housing of the relevant battery cell. The temperature dynamic of the second temperature sensor is higher than the temperature dynamic of the first temperature sensor. Moreover, a third temperature sensor can be arranged in a cooling system of the battery cells in the battery. As a result of the detection of the housing interior temperature, a battery model in the battery control unit can be parameterized more accurately and be evaluated better for simulation and state identification and prediction purposes. The respective temperature sensors are described to be designed as NTC thermistor, PTC thermistor or differential temperature sensor.

One of the development targets in the field of rechargeable batteries, in particular for automotive applications, is volumetric power density. From this requirement, in general very little space is available for auxiliary equipment such as heaters, sensors and electronics intended for being positioned inside a housing of a battery.

Further requirements concerning mechanical properties and manufacturing tolerances in a dimension of thickness for such auxiliary equipment arise from existing conditions inside a battery housing during operation, as these components usually needs to be fixedly attached to the battery cells in an installed state, in which compression loads of typically 15 kN are applied to stacked battery cells, for instance by use of tie-rods or metal bands.

Further, operating conditions within a housing of a battery are known to be highly corrosive, by which high requirements are set with regard to corrosion resistance for reliable operation of such auxiliary equipment.

### SUMMARY

It is therefore an object of the invention to provide a battery heating unit that at least enables heating from inside a battery housing, has reduced space requirements and at the same time meets at least some of the above-mentioned operating condition requirements.

In one aspect of the present invention, the object is achieved by a battery heating unit for use in a rechargeable battery unit which comprises at least one stacked battery block. In particular, the rechargeable battery unit is designed as a rechargeable lithium ion battery.

The proposed battery heating unit includes
at least a first electrically insulating sheet having even, parallel surfaces,
a plurality of electrically resistive, planar heater members that are arranged on one of the surfaces of the first electrically insulating sheet,
a plurality of electrically conductive contact members that are arranged on the surface of the first electrically insulating sheet, and
a plurality of first electrically conductive tracks that are arranged on the surface of the first electrically insulating sheet.

The electrically resistive, planar heater members are electrically connected by electrically conductive tracks of the plurality of first electrically conductive tracks to contact members of the plurality of electrically conductive contact members.

The term “plurality”, as used in this application, shall be understood as a quantity of at least two entities.

In a suitable embodiment, a battery heating unit of compact design can be provided, especially in a direction perpendicular to the surfaces of the first electrically insulating sheet, which corresponds to a preferred direction for stacking battery blocks. As a result, an effect of an installed battery heater unit on a volumetric power density of the rechargeable battery can advantageously be kept small. At the same time, a highly effective heating of the at least one stacked battery block can be accomplished due to an omission of temperature differences due to heat conduction through housing walls and other mechanical interfaces.

In one embodiment, the at least one electrically resistive, planar heater member may be configured for warming up battery cells of the rechargeable battery to a predetermined nominal operation temperature which is known to be beneficial for battery performance. An electric voltage to be provided to the at least one electrically resistive, planar heater member via the electrically conductive contact members may be controlled by a control unit or may be provided to the electrically resistive, planar heater member and may be controlled by the electrical heating member itself.

The term “electrically connected”, as used in this application, shall be understood to encompass galvanic electrical connections as well as connections established by capacitive and/or inductive electromagnetic coupling.

It is further noted herewith that the terms “first”, “second”, etc. are used in this application for distinction purposes only and are not meant to indicate or anticipate a sequence or a priority in any way.

Preferably, the plurality of electrically conductive contact members and the plurality of first electrically conductive tracks are fabricated by applying a printing or a coating process and comprise at least one out of silver, copper and aluminum.

According to at least one aspect of the invention, the battery heating unit comprises a plurality of electrically resistive, planar heater members. The electrically resistive, planar heater members are electrically connected by electrically conductive tracks of the plurality of first electrically conductive tracks to contact members of the plurality of electrically conductive contact members.

This enables to purposefully arrange electrically resistive, planar heater members such that individual regions of the surface of the first electrically insulating sheet are heated by applying an individually predetermined electric power. For instance, peripheral regions of the surface of the first electrically insulating sheet that are known to be subject to larger heat losses at cold ambient temperatures than center regions may be equipped with identically designed electrically resistive, planar heater members at a larger areal density (number of electrically resistive, planar heater members per unit area) than the latter.

An especially gentle warming up of the at least one stacked battery block, with small temperature differences across an individual battery cell resulting from applying low electrical power density can be accomplished if the plurality of electrically resistive, planar heater members overlaps, in a direction perpendicular to the surfaces of the first electrically insulating sheet, a portion of more than or equal to 5%, more preferably more than 10%, and, most preferably, more than 15% of an area of the surface of the first electrically insulating sheet.

In a preferred embodiment, at least one of the electrically resistive, planar heater members comprises a material having an electrical resistivity with a positive temperature coefficient, and in particular made from a cured electrically conductive ink. Electrically resistive inks with positive temperature coefficient are readily commercially available. The electrically resistive ink may be applied by screen printing or ink jet printing or by any other method that appears to be suitable to those skilled in the art.

In this way, the battery heating unit can be furnished in a cost-efficient way with the plurality of individual heater members and/or a large portion of a surface area of the first electrically insulating sheet can be covered by electrically resistive, planar heater members, facilitating an efficient heat transfer to the at least one stacked battery block and effectively preventing a formation of hot spots during warming up.

In another preferred embodiment of the battery heating unit, one end region of one electrically conductive track of the plurality of first electrically conductive tracks that is located distal to the contact member to which it is electrically connected is designed as a first plurality of electrically conductive tap tracks that are arranged in a spaced and parallel manner to each other.

Further, one end region of another electrically conductive track of the plurality of first electrically conductive tracks that is located distal to the contact member to which it is electrically connected is designed as a second plurality of electrically conductive tap tracks that are arranged in a spaced and parallel manner to each other.

The first plurality of electrically conductive tap tracks and the second plurality of electrically conductive tap tracks are arranged galvanically separated from each other and are arranged in an interdigital manner.

Moreover, each electrically resistive, planar heater member of the plurality of electrically resistive, planar heater members is electrically connected with one end to an electrically conductive tap track of the first plurality of electrically conductive tap tracks, and is electrically connected with another end to an electrically conductive tap track of the second plurality of electrically conductive tap tracks.

In this way, the electrically resistive, planar heater members of the plurality of electrically resistive, planar heater members that are disposed all over the surface of the first electrically insulating sheet can efficiently be electrically connected to the first electrically conductive tracks for easy provision of electrical power to each one of the electrically resistive, planar heater members.

For accomplishing an as even as possible warming up of the at least one stacked battery cell, the electrically resistive, planar heater members may be equally spaced along all of two adjacent electrically conductive tap tracks which they are electrically connected to.

In a further preferred embodiment, a numerical majority of the electrically conductive tap tracks of the first plurality of electrically conductive tap tracks extends from the end region of the one of the plurality of first electrically conductive tracks in a perpendicular way, and a numerical majority of the electrically conductive tap tracks of the second plurality of electrically conductive tap tracks extends from the end region of the other one of the plurality of first electrically conductive tracks in a perpendicular way.

In this way, an even distribution of the plurality of electrically resistive, planar heater members on the surface of the first electrically insulating sheet can readily be arranged.

If at least one out of the end regions of the first electrically conductive tracks is arranged to run in parallel to one edge of the first electrically insulating sheet, an even distribution of the plurality of electrically resistive, planar heater members on almost the complete surface of the first electrically insulating sheet can readily be accomplished.

In yet another preferred embodiment, the battery heating unit further comprises at least one temperature sensor formed by a surface-mount device NTC temperature sensor. The temperature sensor can provide a temperature sensor output signal that is indicative of a temperature of the rechargeable battery at the location of the battery heating unit. The sensor output signal, representing a most significant temperature sensed in a preferred region of interest of the at least one stacked battery block, can readily be transferred to a peripheral region of the battery block for further evaluation. For example, the temperature sensor output signal may beneficially be transferred to a control unit for temperature control purposes. The at least one temperature sensor may be electrically connected to electrically conductive tracks of the plurality of first electrically conductive tracks. However, it is also contemplated that the at least one temperature sensor is electrically connected to electrically conductive tracks that are specifically assigned only to the at least one temperature sensor.

With particular benefit, a maximum total height, as measured in a direction perpendicular to the surfaces of the first electrically insulating sheet, of the electrically resistive, planar heater members of the plurality of electrically resistive, planar heater members, of the electrically conductive tracks of the plurality of first electrically conductive tracks, the first electrically insulating sheet and, if applicable, the at least one temperature sensor is less than or equal to 1.0 mm.

In this way, absolute changes of dimensions of the first electrically insulating sheet, the electrically resistive, planar heater members, the first electrically conductive tracks, the first electrically insulating sheet and, if applicable, the at least one temperature sensor as measured in the direction perpendicular to the surfaces of the first electrically insulating sheet can inherently be kept small. By that, thermomechanical forces which are regularly being generated due to temperature changes and differences in thermal expansion coefficients of involved materials can be kept low and, especially, below maximum tolerable mechanical stress levels of the involved materials.

In one embodiment, the battery heating unit further comprises an electrically insulating cover that is arranged on and is adhesively attached to top surfaces, which are facing away from the first electrically insulating sheet, of at least a portion of the electrically resistive, planar heater members, of the first electrically conductive tracks and, if applicable, of the at least one temperature sensor.

In this way, a battery heating unit with an efficient corrosion protection can be provided.

In one preferred embodiment of the battery heating unit, at least one out of the plurality of electrically conductive contact members and the plurality of first electrically conductive tracks comprises cured electrically conductive ink.

Electrically conductive inks are commercially available. In this way, an application of high-precision, cost-effective manufacturing methods such as screen printing and ink jet printing is facilitated, resulting in low manufacturing tolerances, in particular for dimensions in the direction perpendicular to the surfaces of the first electrically insulating sheet or the second electrically insulating sheet. Low manufacturing tolerances in this dimension can enable a uniform compression load in a compressed state of the battery heating unit.

Preferably, the cured electrically conductive ink comprises silver.

In another preferred embodiment, the battery heating unit comprises a plurality of electrically conductive terminal members, wherein
each electrically conductive terminal member of the plurality of electrically conductive terminal members is electrically connected to at least one electrically conductive contact member of the plurality of electrically conductive contact members, and
the plurality of electrically conductive terminal members (48) is arranged in a coplanar manner, wherein the plane of arrangement is arranged to form a right angle with the bottom surface of the second electrically insulating sheet.

In this way, an interface for providing electric power to the electrically resistive, planar heater members from outside of the battery cells to the core region of the battery cells and/or, if applicable, for transferring temperature sensor output signals to the outside of the battery cells can readily be provided. Further, the plurality of electrically conductive terminal members may ensure electrical and mechanical connections to an electronic control unit.

With benefits, most part of at least one of the first electrically insulating sheet is made from a plastic material that is selected from a group of plastic materials formed by polyethylene terephthalate (PET), polyimide (PI), polyetherimide (PEI), polyethylene naphthalate (PEN), polyoxymethylene (POM), polamide (PA), polyphthalamide (PPA), polyether ether ketone (PEEK) and combinations of at least two of these plastic materials.

The term “most part of”, as used in this application, shall particularly be understood as equal to or more than 50%, more preferably more than 70%, and, most preferably, more than 80% in volume, and shall encompass a part of 100%, i.e. completely.

These materials allow for easy manufacturing, and durable, cost-efficient electrically insulating sheets of low manufacturing tolerances can be provided.

In another aspect of the present invention, a rechargeable electrochemical battery unit, in particular for automotive applications, is provided. The rechargeable electrochemical battery unit comprises
a battery housing,
at least one battery block that includes a plurality of stacked battery cells, the at least one battery block being at least partially arranged inside the battery housing, and
at least one embodiment of the disclosed battery heating unit being arranged in the at least one battery block.

The advantages presented for the battery heating unit in accordance with the invention also apply to the rechargeable electrochemical battery unit.

### BRIEF DESCRIPTION OF THE DRAWINGS

Further details and advantages of the present invention will be apparent from the following detailed description of not limiting embodiments with reference to the attached drawing, wherein:

FIG. 1 schematically illustrates perspective view of a battery unit for automotive application, including a temperature control unit in accordance with an embodiment of the invention;

FIG. 2 shows a schematic and partially exploded perspective view of an embodiment of the battery heating unit in accordance with the invention; and

FIG. 3 schematically illustrates an alternative embodiment of the battery heating unit in accordance with the invention in a top view.

### DESCRIPTION OF THE ILLUSTRATED EMBODIMENTS

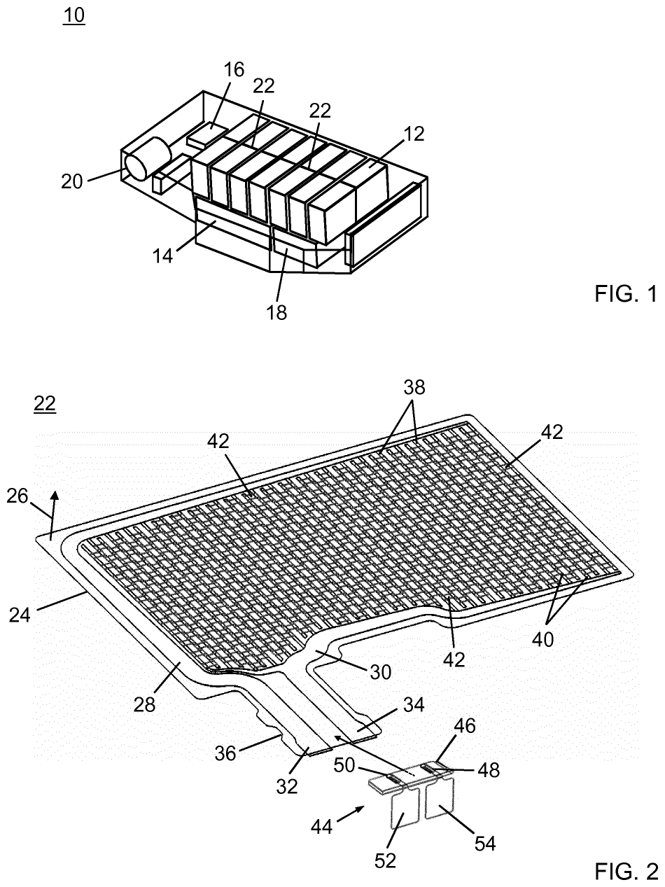

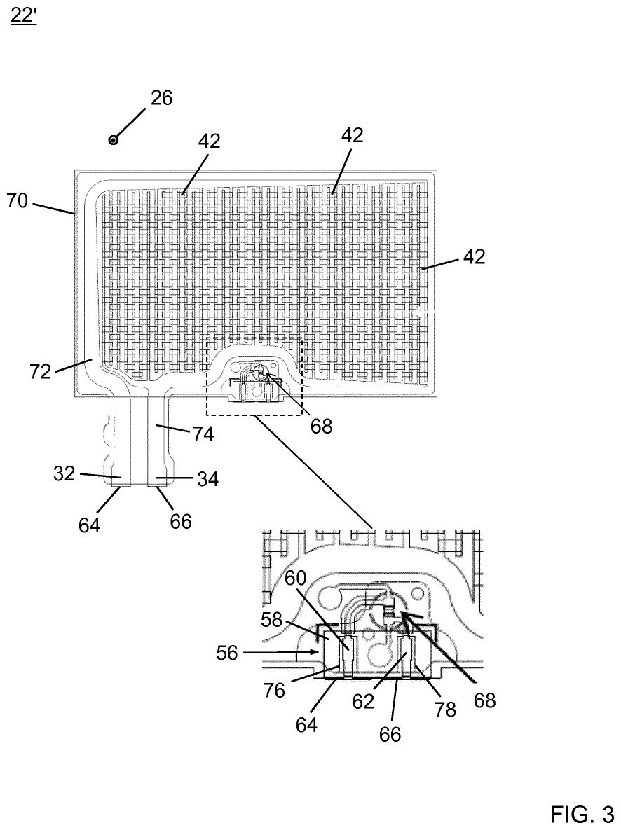

FIG. 1 schematically illustrates an assembly of a rechargeable electrochemical battery unit 10, namely a lithium ion battery unit for automotive application. In an operation state, the assembly is contained in a housing of the battery unit 10, which is not completely shown in FIG. 1 for clarity purposes. The battery unit 10 comprises a plurality of seven battery blocks 12, each battery block 12 including a plurality of stacked battery cells, wherein the battery blocks 12 are tightly packed in a parallel and juxtaposed manner. The battery unit 10 further includes a power electronics unit 14, make-break switches 18 electrically connected to the plurality of battery blocks 12, as is well known in the art, and cooling means formed by an air blower 20 for cooling the battery blocks 12.

Furthermore, the battery unit 10 includes a plurality of seven battery heating units 22. One battery heating unit 22 each is installed in each of the seven battery blocks 12. The fixation of each battery heating unit 22 is established by the compressed battery block 12 of stacked battery cells. Thereby, each of the battery heating units 22 is exposed to a uniform compression load of up to 15 kN in the installed situation.

A schematic and partially exploded perspective view of one of the battery heating units 22 pursuant to FIG. 1 is shown in FIG. 2. As the seven battery heating units 22 are all identically designed, it is sufficient to describe the features of the battery heating units 22 with reference to one of the battery heating units 22 in an exemplary manner.

The battery heating unit 22 comprises a first electrically insulating sheet 24 having even surfaces, which are substantially arranged in parallel. The first electrically insulating sheet has a basically rectangular shape, is completely made from polyethylene terephthalate (PET) and has a thickness, as measured in a direction 26 perpendicular to its surfaces, of 125 μm.

Then, the battery heating unit 22 comprises a plurality of two first electrically conductive tracks 28, 30 that are arranged on one of the surfaces of the first electrically insulating sheet 24, and that are abutting and are electrically connected to slightly wider contact members 32, 34 of a plurality of electrically conductive contact members 32, 34 of the battery heating unit 22 that are arranged on a surface of a generally rectangular-shaped extension 36 of the first electrically insulating sheet 24. The extension 36 is positioned at one of the longer edges of the first electrically insulating sheet 24, wherein the surface of the first electrically insulating sheet 24 and the surface of the generally rectangular-shaped extension 36 coincide. The first electrically insulating sheet 24 and the extension 36 are integrally formed and made from the same material; i.e. PET.

The plurality of first electrically conductive tracks 28, 30 has been attached to the first electrically insulating sheet 24 by applying a screen-printing method, using an electrically conductive ink that comprises silver. Alternative manufacturing methods, such as laminating of copper foil onto the first electrically insulating sheet 24, are also contemplated.

In the following, a region of any one of the first electrically conductive tracks 28, 30 that is located distal to the contact member 32, 34 to which the specific first electrically conductive track 28, 30 is electrically connected is referred to as the end region of the specific first electrically conductive track 28, 30.

The end region of the one first electrically conductive track 28 of the plurality of two first electrically conductive tracks 28, 30 is designed as a first plurality of electrically conductive tap tracks 38 that are arranged in a spaced and parallel manner to each other. The first plurality of electrically conductive tap tracks 38 is arranged to run in parallel to shorter edges of the first electrically insulating sheet 24. A numerical majority of the electrically conductive tap tracks 38 of the first plurality of electrically conductive tap tracks 38 extends from the one first electrically conductive track 28 in a substantially perpendicular way.

The end region of the other first electrically conductive track 30 of the plurality of two first electrically conductive tracks 28, 30 is designed as a second plurality of electrically conductive tap tracks 40 that are arranged in a spaced and parallel manner to each other. The second plurality of electrically conductive tap tracks 40 is arranged to run in parallel to the shorter edges of the first electrically insulating sheet 24. A numerical majority of the electrically conductive tap tracks 40 of the second plurality of electrically conductive tap tracks 40 extends from the other first electrically conductive track 30 in a substantially perpendicular way.

The first plurality of electrically conductive tap tracks 38 and the second plurality of electrically conductive tap tracks 40 are arranged galvanically separated from each other and are arranged in an interdigitated manner on the surface of the first electrically insulating sheet 24.

The battery heating unit 22 further includes a plurality of several hundreds of electrically resistive, planar heater members 42 that is arranged on the same surface of the first electrically insulating sheet 24 as is the plurality of first electrically conductive tracks 28, 30. The electrically resistive, planar heater members 42 are made by applying a screen printing method using an electrically conductive ink comprising a material that has an electrical resistivity with a positive temperature coefficient, followed by a step of curing the ink.

When an electric voltage source is used to provide electric power to the electrically resistive, planar heater members 42, the effect of the electrical resistivity increasing with temperature will eventually limit a heating current when the battery block 12 reaches a specific temperature. The specific temperature is predetermined by the properties of the electrically conductive ink used for making the electrically resistive, planar heater members 42. In other words, the electrically resistive, planar heater members 42 are designed for self-regulated operation to reach a predetermined temperature when electrically connected to an electric voltage source (not shown).

Each one of the electrically resistive, planar heater members 42 is electrically connected with one end to an electrically conductive tap track 38 of the first plurality of electrically conductive tap tracks 38, and by that, to the one 28 of the two first electrically conductive tracks 28, 30 and one 32 of the contact members 32, 34. Each one of the electrically resistive, planar heater members 42 is electrically connected with another end to an electrically conductive tap track 40 of the second plurality of electrically conductive tap tracks 40 and, by that, to the other one 30 of the two first electrically conductive tracks 28, 30 and to another one 34 of the contact members 32, 34.

The electrically resistive, planar heater members 42 are equally spaced along two adjacent electrically conductive tap tracks, one of the first plurality of electrically conductive tap tracks 38 and one of the second plurality of electrically conductive tap tracks 40, which they are electrically connected to. The plurality of electrically resistive, planar heater members 42 overlaps, in the direction 26 perpendicular to the surfaces of the first electrically insulating sheet 24, a portion of about 24% of a total area of the surface of the first electrically insulating sheet 24. By that, an especially gentle warming up of the stacked battery blocks 12 with small temperature differences across an individual battery cell can be accomplished. In principle, a lower coverage ratio of electrically resistive, planar heater members 42 is also contemplated but should not be designed to fall below a minimum coverage ratio of 5%.

The battery heating unit 22 further comprises a contact board 44. The contact board 44 includes a second electrically insulating sheet 46 having an even upper surface and an even bottom surface, substantially arranged in parallel to each other, a plurality of second electrically conductive tracks 48, 50 that are arranged on the bottom surface of the second electrically insulating sheet 46 and a plurality of two electrically conductive terminal members 52, 54.

Each electrically conductive terminal member 52, 54 is electrically connected to one of the second electrically conductive tracks 48, 50 of the plurality of second electrically conductive tracks 48, 50. As indicated in FIG. 1 by an arrow, the contact board 44 is attachable to the first electrically insulating sheet 24 such that each electrically conductive contact member 32, 34 of the plurality of electrically conductive contact members 32, 34 is electrically connected to one of the second electrically conductive tracks 48, 50 of the plurality of second electrically conductive tracks 48, 50. The plurality of two electrically conductive terminal members 52, 54 is arranged in a coplanar manner. The plane of arrangement of the plurality of two electrically conductive terminal members 52, 54 is arranged to form a right angle with the bottom surface of the second electrically insulating sheet 46.

For improved and robust corrosion protection, an electrically insulating cover (not shown) is arranged on and is adhesively attached to top surfaces, which are facing away from the first electrically insulating sheet 24, of the electrically resistive, planar heater members 42 and of the first electrically conductive tracks 28, 30 of the plurality of first electrically conductive tracks 28, 30 by applying a polyvinyl chloride (PVC) coating having a maximum thickness of about 800 μm. As an additional option, an electrically insulating cover comprising UV-curable epoxy resin may be applied on the top surfaces of the electrically resistive, planar heater members 42, which, as a side effect, mechanically reinforces the electrically resistive, planar heater members 42 in order to withstand a compression load applied to the battery heating unit 22 in a state of being installed in the battery block 12 of compressed and stacked battery cells.

Due to the use of the screen-printed electrically resistive, planar heater members 42 and the flatness of the pluralities of first electrically conductive tracks 28, 30, a maximum total height, as measured in the direction 26 perpendicular to the surfaces of the first electrically insulating sheet 24, of the electrically resistive, planar heater members 42, of the first electrically conductive tracks 28, 30 and the first electrically insulating sheet 24 is only about 950 μm, so that a volumetric power density of the battery blocks 12 is virtually not affected.

A top view of an alternative embodiment 22′ of the battery heating unit in accordance with the invention is schematically illustrated in FIG. 2. For the sake of brevity, only differences to the embodiment disclosed beforehand will be described.

The alternative embodiment 22′ of the battery heating unit further comprises a temperature sensor 68, which is formed by a surface-mount device (SMD) NTC (negative temperature coefficient) temperature sensor. The NTC temperature sensor is arranged on a surface of a first electrically insulating sheet 70 within an area that is defined by a longer edge of the first electrically insulating sheet 70 and one 74 of a plurality of two first electrically conductive tracks 72, 74, which has been modified in comparison to the first embodiment of the battery heating unit 22 by giving it two counter-rotating 90° turns. Each one of the two first electrically conductive tracks 72, 74 is electrically connected to one of contact members 32, 34 in the same way as described for the first contact board 44 and the two first electrically conductive tracks 28, 30 of the first embodiment of the battery heating unit 22.

The NTC temperature sensor is electrically connected to two contact members 76, 78 that are arranged on the surface of the first electrically insulating sheet 70.

The battery heating unit 22′ further comprises a second contact board 56. The second contact board 56 includes a third electrically insulating sheet 58 having an even upper surface and an even bottom surface, substantially arranged in parallel to each other, a plurality of third electrically conductive tracks 60, 62 that are arranged on the bottom surface of the third electrically insulating sheet 58, and a plurality of two electrically conductive terminal members 64, 66.

Each electrically conductive terminal member 64, 66 of the plurality of two electrically conductive terminal members 64, 66 is electrically connected to one of the third electrically conductive tracks 60, 62. As indicated in FIG. 2, the second contact board 56 is attachable to the first electrically insulating sheet 70 such that the electrically conductive contact members 76, 78 are electrically connected to one of the third electrically conductive tracks 60, 62.

The plurality of two electrically conductive terminal members 64, 66 is arranged in a coplanar manner. The plane of arrangement of the plurality of two electrically conductive terminal members 64, 66 is arranged to form a right angle with the bottom surface of the third electrically insulating sheet 58.

As described for the first embodiment, the alternative embodiment 22′ of the battery heating unit is furnished with an electrically insulating cover by applying a PVC coating (not shown) of about 800 μm for improved and robust corrosion protection. As an additional option, an electrically insulating cover comprising UV-curable epoxy resin may be applied on the top surface of the SMD NTC temperature sensor in support of withstanding a compression load applied to the battery heating unit 22′ in a state of being installed in the battery block 12 of compressed and stacked battery cells. Such epoxy resin materials are well known for use as “glob-tops” for instance in the field of chip-on-board technology, and are readily commercially available.

The battery unit 10 also comprises a control unit 16 (FIG. 1) that is configured to receive an output signal provided by the temperature sensor 68 of the battery heating unit 22′ and is configured to control operation of the air blower 20 for cooling the plurality of battery blocks 12, if a predetermined maximum tolerable temperature is reached.

While the invention has been illustrated and described in detail in the drawings and foregoing description, such illustration and description are to be considered illustrative or exemplary and not restrictive; the invention is not limited to the disclosed embodiments.

Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The term “plurality” shall be understood as a quantity of at least two entities. The mere fact that certain measures are recited in mutually different dependent claims does not indicate that a combination of these measures cannot be used to advantage. Any reference signs in the claims should not be construed as limiting scope.

1. A battery heating unit for use in a rechargeable battery unit comprising at least one stacked battery block, the battery heating unit including
at least a first electrically insulating sheet having even, parallel surfaces,
a plurality of electrically resistive, planar heater members, arranged on one of the surfaces of the first electrically insulating sheet,
a plurality of electrically conductive contact members that are arranged on the surface of the first electrically insulating sheet,
a plurality of first electrically conductive tracks that are arranged on the surface of the first electrically insulating sheet,
wherein the electrically resistive, planar heater members are electrically connected by at least some of the plurality of first electrically conductive tracks to at least some of the plurality of electrically conductive contact members.

2. The battery heating unit as claimed in claim 1, wherein the plurality of electrically resistive, planar heater members overlaps, in a direction perpendicular to the surfaces of the first electrically insulating sheet, a portion of more than or equal to 5% of an area of the surface of the first electrically insulating sheet.

3. The battery heating unit as claimed in claim 1, wherein at least one of the electrically resistive, planar heater members comprises a material having an electrical resistivity with a positive temperature coefficient.

4. The battery heating unit as claimed in claim 1, wherein
one end region of a first electrically conductive track of the plurality of electrically conductive tracks that is located distal to the contact member to which it is electrically connected comprises a first plurality of electrically conductive tap tracks that are arranged in a spaced and parallel manner to each other, and wherein
one end region of a second electrically conductive track of the plurality of electrically conductive tracks that is located distal to the contact member to which it is electrically connected comprises a second plurality of electrically conductive tap tracks that are arranged in a spaced and parallel manner to each other, and wherein
the first plurality of electrically conductive tap tracks and the second plurality of electrically conductive tap tracks are arranged galvanically separated from each other and are arranged in an interdigital manner, and wherein
each of the electrically resistive, planar heater members is electrically connected with one end to an electrically conductive tap track of the first plurality of electrically conductive tap tracks, and is electrically connected with another end to an electrically conductive tap track of the second plurality of electrically conductive tap tracks.

5. The battery heating unit as claimed in claim 4, wherein a numerical majority of the electrically conductive tap tracks of the first plurality of electrically conductive tap tracks extends from the end region of the first electrically conductive track in a perpendicular way, and a numerical majority of the electrically conductive tap tracks of the second plurality of electrically conductive tap tracks extends from the end region of the second electrically conductive track in a perpendicular way.

6. The battery heating unit as claimed in claim 4, wherein at least one out of the end region of the first electrically conductive track and the end region of the second electrically conductive track is arranged to run in parallel to one edge of the first electrically insulating sheet.

7. The battery heating unit as claimed in claim 1, further comprising at least one temperature sensor formed by a surface-mount device NTC temperature sensor.

8. The battery heating unit as claimed in claim 1, wherein a maximum total height, as measured in the direction perpendicular to the surfaces of the first electrically insulating sheet, of (i) the electrically resistive, planar heater members, (ii) the electrically conductive tracks, and (iii) the first electrically insulating sheet is less than or equal to 1.0 mm.

9. The battery heating unit as claimed in claim 1, further comprising an electrically insulating cover that is arranged on and is adhesively attached to top surfaces, which are facing away from the first electrically insulating sheet, of at least a portion of the electrically resistive, planar heater members, and of the electrically conductive tracks.

10. The battery heating unit as claimed in claim 1, wherein at least one out of the plurality of electrically conductive contact members and the plurality of electrically conductive tracks comprises cured electrically conductive ink.

11. The battery heating unit as claimed in claim 1, further comprising a plurality of electrically conductive terminal members and a second electrically insulating sheet having a top surface and a bottom surface, wherein
each of the electrically conductive terminal members is electrically connected to at least one of the electrically conductive contact members, and
the plurality of electrically conductive terminal members is arranged in a coplanar manner, wherein the plane of arrangement is arranged to form a right angle with the bottom surface of the second electrically insulating sheet.

12. The battery heating unit as claimed in claim 1, wherein at least part of the first electrically insulating sheet is made from a plastic material that is selected from a group of plastic materials formed by polyethylene terephthalate PET, polyimide PI, polyetherimide PEI, polyethylene naphthalate PEN, polyoxymethylene POM, polamide PA, polyphthalamide PPA, polyether ether ketone PEEK and combinations of at least two of these plastic materials.

13. A rechargeable electrochemical battery unit, comprising
a battery housing,
at least one battery block that includes a plurality of stacked battery cells, the at least one battery block being at least partially arranged inside the battery housing, and
at least one battery heating unit as claimed in claim 1, being arranged in the at least one battery block.

14. The rechargeable electrochemical battery unit as claimed in claim 13, wherein the at least one battery block comprises a rechargeable lithium ion battery.

15. The rechargeable electrochemical battery unit as claimed in claim 14, wherein the rechargeable lithium ion battery is an automotive battery.
